(19) United States
(12) Patent Application Publication
(10) Pub. No.: US 2026/0236432 A1
(43) Pub. Date: Aug. 13, 2026

(54) SYSTEMS AND METHODS FOR TRANSFORMING AND MANAGING ELECTRONIC DATA FILES FOR A DATA NETWORK INTEGRATION PROCESS

(71) Applicant: VIZIENT, INC., Irving, TX (US)

(72) Inventors: Michael Busch, Irving, TX (US); Robert C. Browne, Irving, TX (US)

(21) Appl. No.: 19/534,431

(22) Filed: Feb. 9, 2026

Related U.S. Application Data
(60) Provisional application No. 63/755,846, filed on Feb. 7, 2025.

(51) Int. Cl. G06F 16/11

(52) U.S. Cl. CPC G06F 16/116

(57) ABSTRACT

The disclosed system enhances data integration processes by transforming existing electronic data files into a comparative format for evaluation against new data inputs. Utilizing a data transformation engine, the system normalizes terms and aligns data file parameters with data input metrics. In some embodiments, the system generates comprehensive comparison reports that quantify alternatives in terms of data utilization, resource efficiency, conversion rates, data quality, and standardization. A graphical user interface facilitates user interaction, allowing the selection and integration of data files into data integration plans. The system supports filtering based on file attributes and assesses the impact of data files on data network components. The system provides pre-submit access to data file details and conducts independent analyses to identify resource optimization opportunities, empowering decision-makers to optimize data integration pathways, ensuring efficient resource allocation and alignment with operational goals.

### CROSS REFERENCE TO RELATED APPLICATION

This application claims priority and benefit of U.S. Provisional Application No. 63/755,846, filed Feb. 7, 2025, the contents of which are incorporated herein by reference in its entirety.

### FIELD OF THE DISCLOSURE

The present disclosure is generally related to data transformation systems, and more particularly, to a decision intelligence (DI)-based computerized framework for transforming data files and data inputs in a data network's data integration process to enable accurate and efficient processing of such data for a data center's computer system.

### SUMMARY

In some embodiments, the disclosure is directed to a computer-implemented system that enhances data integration processes through the analysis of existing and/or available electronic data files. In some embodiments, the system analyzes the scope of each data file in relation to current data network integration needs. The system transforms data from these files into a comparative format against data inputs from data sources through a data transformation engine, which, in some embodiments, normalizes terms and compares them with data input parameters. In some embodiments, the system then generates a comprehensive comparison report that quantifies alternatives in terms of data utilization, resource efficiency, conversion rates, data quality, and/or standardization, as non-limiting examples, which is then displayed on a graphical user interface (“GUI”). In some embodiments, the GUI is configured to allow users to select existing and/or available data files to incorporate into the scope of a data integration plan for a data network.

Some non-limiting data files suitable for the system include local data files, direct data files, aggregation group data files, custom data files, and/or national data files. In some embodiments, the system is configured to filter data files based on attributes such as file type, participation status, and commitment type, and display the filtered data in a categorized list for user selection. In some embodiments, the system retrieves and analyzes current tier data metrics and compliance performance data for data files the user is engaging with, and/or transforms the data into a detailed metrics and compliance report. In some embodiments, the system is configured to incorporate selected data files into the data integration planning process, transforming data file information into strategic recommendations for data integration pathways and combinations. In some embodiments, the system includes functionality to display a difference between current data inputs in a plan and existing data files.

In some embodiments, the system assesses the aggregate impacts of selected data files on one or more components of a data network, which may include one or more data centers each with one or more data nodes, and outputs impact data into a participants impact report. In some embodiments, the system allows users to select specific data files that they are considering (available) or are currently using (existing), which could be part of a new data integration process that the data network wants to evaluate. In some embodiments, the system analyzes the existing and/or available data files selected via the GUI and displays their overall effects on each data center or data node within a data network. In some embodiments, system factors used in the analysis include one or more of resource implications, resource allocation, compliance with data file terms, and alignment with operational or analytical goals.

In some embodiments, the system takes the raw data from the analysis and processes it to create a comprehensive view of the impacts on the GUI. Some embodiments include a computer-implemented step of aggregating data across one or more metrics, such as resource savings, efficiency improvements, and/or changes in data service delivery. In some embodiments, the transformed data is displayed as a participants impact report, which provides a detailed summary of how each data file affects the different parts of a data network. In some embodiments, the report is configured to identify areas in a data network where resources are being used efficiently and/or where improvements can be made to more efficiently use computer resources. In some embodiments, the report includes key insights and metrics, improving the data integration process by allowing decision-makers to understand the broader implications of their data source choices.

In some embodiments, the system is configured to enable pre-submit access to data file details during the creation of a data integration proposal. In some embodiments, the system is configured to inform other data sources of the presence of national data files, and/or display limited aggregated details of data files (e.g., national data files) to one or more data sources. In some embodiments, the system is configured to display a catalog and categories page with existing data files. In some embodiments, the system is configured to execute an independent analysis of existing data files outside of a data integration event, transforming data file information into on-demand data integration analytics that identifies opportunities to optimize resources, reduce variation, and/or improve compliance.

### DESCRIPTION OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates a block diagram of an example configuration within which the systems and methods disclosed herein can be implemented according to some embodiments of the present disclosure;

FIG. 2 depicts a block diagram illustrating components of an example system according to some embodiments of the present disclosure;

FIG. 3 illustrates an example configuration workflow according to some embodiments of the present disclosure;

FIG. 4 illustrates an example execution workflow according to some embodiments of the present disclosure;

FIG. 5 depicts an example implementation of an architecture according to some embodiments of the present disclosure;

FIG. 6 depicts an example implementation of an architecture according to some embodiments of the present disclosure;

FIG. 7 is a block diagram illustrating a computing device showing an example of a client or server device used in some embodiments of the present disclosure.

FIG. 8 illustrates a data management GUI configured to enhance the data integration planning process by providing a comprehensive view of relevant data files, data sources, and/or data inputs according to some embodiments of the present disclosure;

FIG. 9 depicts a data management GUI configured to optimize the data integration planning process by incorporating added data files into the decision-making framework according to some embodiments of the present disclosure;

FIG. 10 illustrates a data management GUI configured to enhance the data integration planning process by displaying a detailed view of included data files on a data plan details page according to some embodiments of the present disclosure;

FIG. 11 shows a data management GUI configured to provide a comprehensive analysis of the impact of selected data files on individual data nodes or data centers on a participants impact page according to some embodiments of the present disclosure;

FIG. 12 illustrates a data management GUI displaying insights and communication capabilities according to some embodiments of the present disclosure;

FIG. 13 illustrates a data management GUI configured to display enhanced analytical capabilities for evaluating data inputs from data networks according to some embodiments of the present disclosure;

FIG. 14 shows a data management GUI that integrates existing data files into a catalog and categories page according to some embodiments of the present disclosure; and

FIG. 15 illustrates a data management GUI feature that improves the enrollment process for data networks by offering a direct pathway to engage with eligible data files, in accordance with some embodiments.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; examples according to some embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in some embodiments” as used herein does not necessarily refer to a different embodiment. It is intended, for example, that claimed subject matter include combinations of features, in whole or in part, in accordance with some embodiments, as they are all part of the same system.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or otherwise described herein according to some embodiments. In some embodiments, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. In some embodiments, program steps described herein but not shown in the blocks can be implemented before, after, and/or simultaneously with the blocks.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data. In some embodiments, computer readable medium may include communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication. By way of example, and not limitation, the term “server” can refer to a single, physical processor with associated communications and data storage and database facilities, or “server” can refer to a networked or clustered complex of processors and associated network and storage devices, as well as operating software and one or more database systems and application software that support the services provided by the server. Cloud servers are non-limiting examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub- networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th}, or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device, which may include one or more computers, may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack- mounted servers, desktop computers, laptop computers, set top boxes, integrated devices combining various features, such as two or more features of the foregoing devices, or the like.

For purposes of this disclosure, a client (or user, entity, subscriber, or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

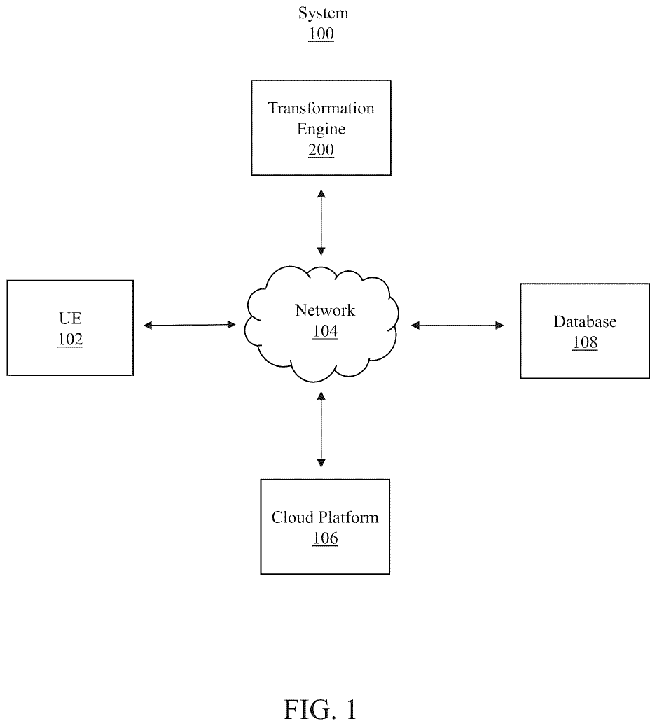

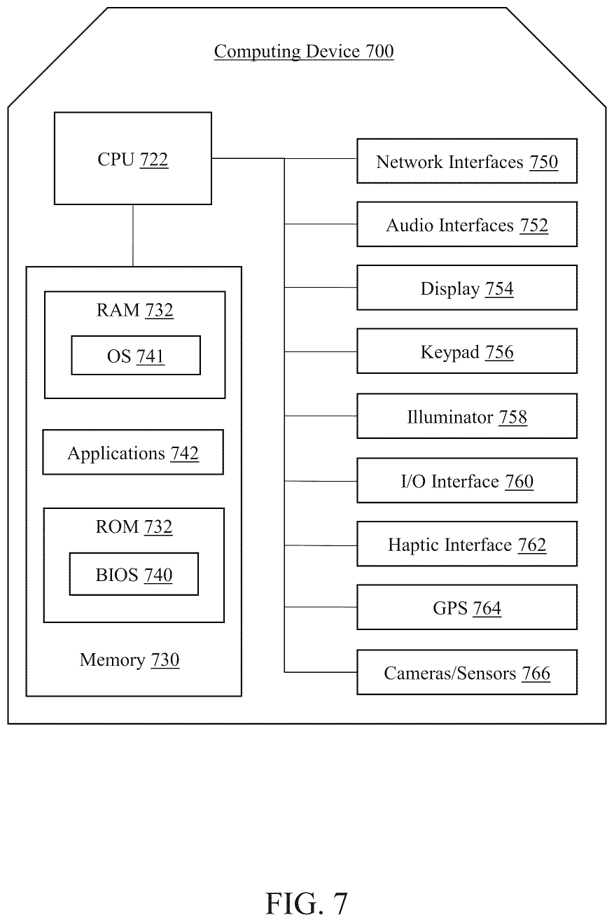

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 7), network 104, cloud platform 106, database 108 and transformation engine 200. It should be understood that while system 100 is depicted as including such components, the depiction should not be construed as limiting, as one of ordinary skill in the art would readily understand that varying numbers of UEs, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a desktop computer, a server, a mobile (smart) phone, tablet, laptop, sensor, IoT device, autonomous machine, appliance, and/or any device equipped with a cellular and/or wireless or wired transceiver. For example, UE 102 can be a smart phone with various Apps installed, which as discussed below in more detail, can enable the identification and/or collection of activity information of the user to guide actual App and/or UE 102 usage.

In some embodiments, one or more peripheral devices (not shown) can be connected to UE 102, and can be any type of peripheral device, such as, but not limited to, a wearable device (e.g., smart watch), printer, speaker, sensor, and the like. In some embodiments, peripheral device can be any type of device that is connectable to UE 102 via any type of known or to be known pairing mechanism, including, but not limited to, WiFi, Bluetooth™, Bluetooth Low Energy (BLE), NFC, and the like. For example, the peripheral device can be a speaker that connectively pairs with UE 102.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud platform 106 may be any type of cloud operating platform and/or network-based platform upon which applications, operations, and/or other forms of network resources may be located. For example, cloud platform 106 may be a service provider and/or network provider from where services and/or applications may be accessed, sourced, or executed from. For example, platform 106 can represent the cloud-based architecture associated with a smart home or network provider, which has associated network resources hosted on the internet or private network (e.g., network 104), which enables (via transformation engine 200) the device control and management discussed herein.

In some embodiments, cloud platform 106 may include a server(s) and/or a database of information which is accessible over network 104. In some embodiments, a database 108 of cloud platform 106 may store a dataset of data and metadata associated with local and/or network information related to a user(s) of the components of system 100 and/or each of the components of system 100 (e.g., UE 102, the services and applications provided by cloud platform 106, and/or transformation engine 200). In some embodiments, database 108 may include a plurality of databases that store existing and/or available contracts, as a non-limiting example.

In some embodiments, cloud platform 106 can provide a private/proprietary management platform, whereby transformation engine 200, discussed infra, corresponds to the novel functionality platform 106 enables, hosts, and provides to a network 104 and other devices/platforms operating thereon.

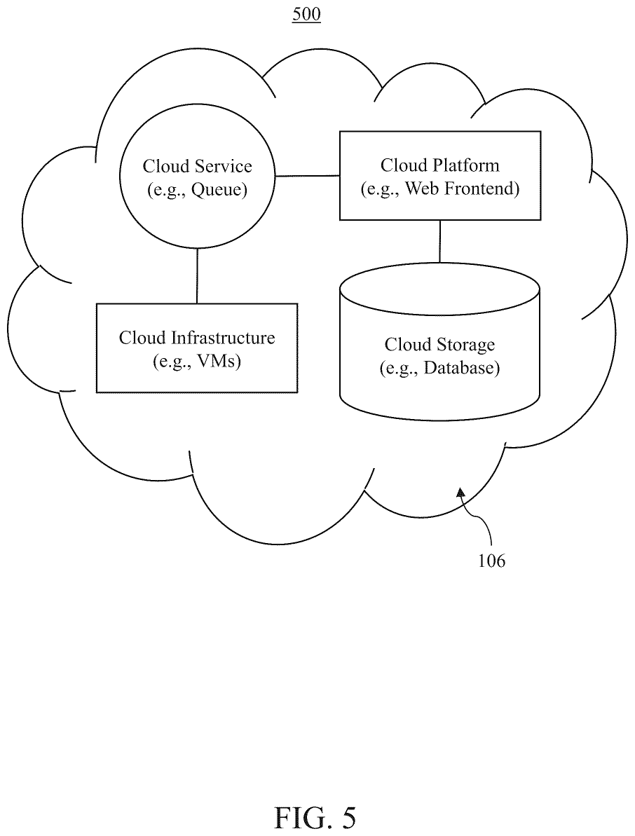

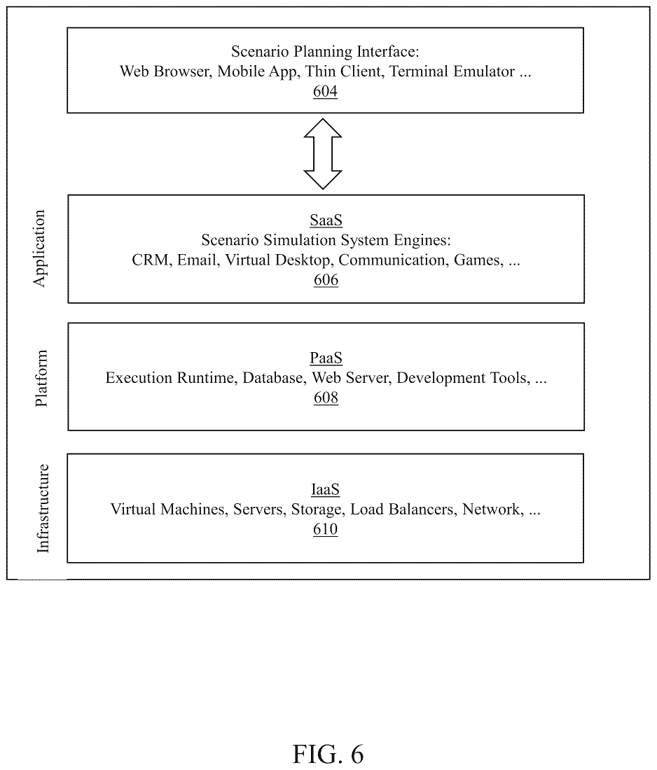

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 120 such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to data storage for a platform (e.g., a network-hosted platform, such as cloud platform 106, as discussed supra) or a plurality of platforms, which store information related to the data integration process. Database 108 may receive storage instructions/requests from, for example, transformation engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Transformation engine 200, as discussed above and further below in more detail, can include components for the disclosed functionality. According to some embodiments, transformation engine 200 may be a special purpose machine or processor and can be hosted by a device on network 104, within cloud platform 106, and/or on UE 102. In some embodiments, transformation engine 200 may be hosted by a server and/or set of servers associated with cloud platform 106.

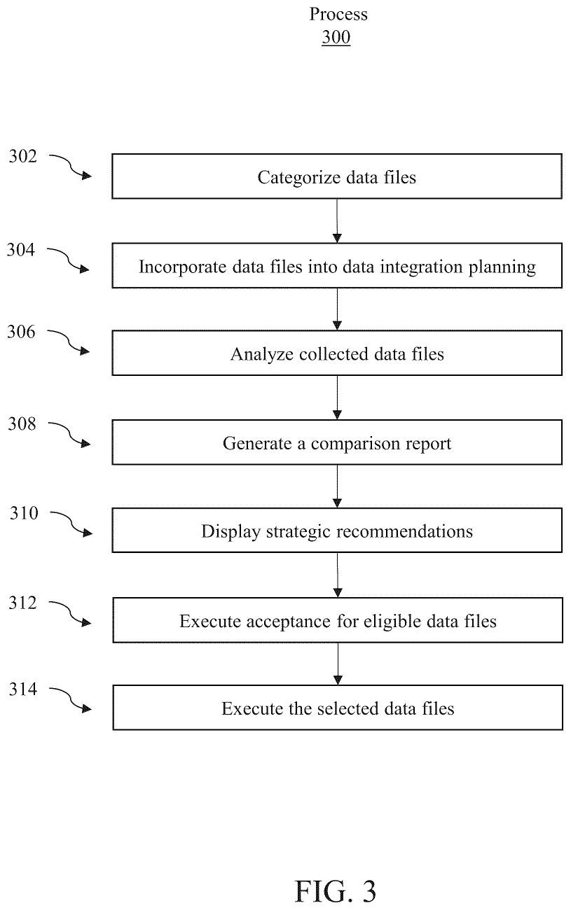

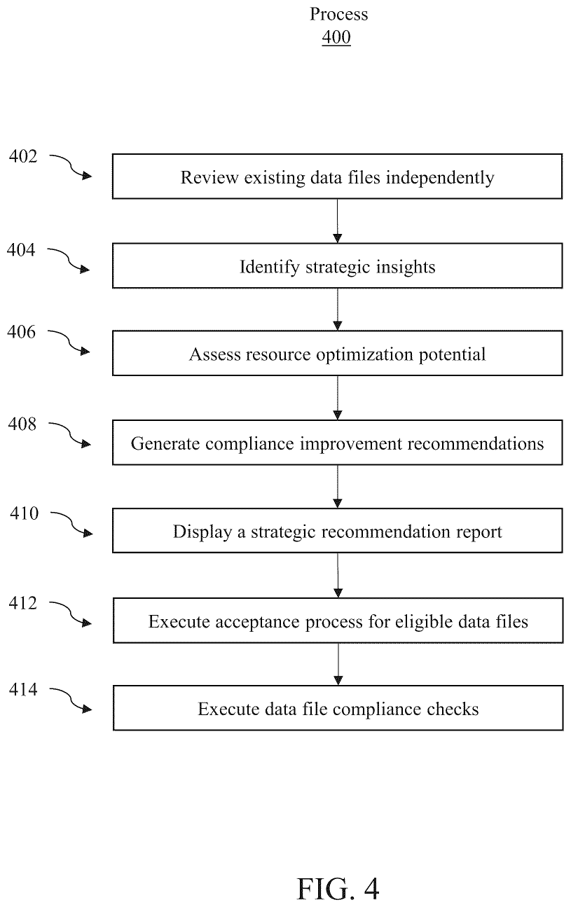

According to some embodiments, as discussed in more detail below, transformation engine 200 may be configured to implement and/or control a plurality of services and/or microservices, where each of the plurality of services/microservices are configured to execute a plurality of workflows associated with performing the disclosed application control and management framework. Non-limiting embodiments of such workflows are provided below in relation to at least FIGS. 3-4.

According to some embodiments, as discussed above, transformation engine 200 may function as an application provided by cloud platform 106. In some embodiments, transformation engine 200 may function as an application installed on a server(s), network location and/or other type of network resource associated with platform 106. In some embodiments, transformation engine 200 may function as application installed and/or executing on UE 102. In some embodiments, such application may be a web-based application accessed by UE 102 over network 104 from cloud platform 106. In some embodiments, transformation engine 200 may be configured and/or installed as an augmenting script, program, or application (e.g., a plug-in or extension) to another application or program provided by cloud platform 106 and/or executing on UE 102.

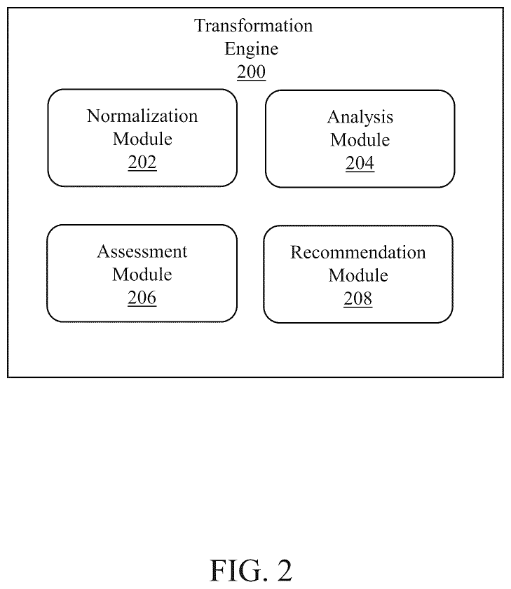

As illustrated in FIG. 2, according to some embodiments, transformation engine 200 includes normalization module 202, comparative analysis module 204, impact assessment module 206, and strategic recommendation module 208. In some embodiments, the normalization module 202 is configured to standardize data formats and units across different data files and data inputs, converting various data types into a common format, aligning data file terms, and/or ensuring consistency in data file and data input units and metrics. In some embodiments, the analysis module 204 executes algorithms for comparing existing data files with new data inputs from data networks, evaluating various parameters such as metrics, terms, compliance, and performance to identify the best options. In some embodiments, the assessment module 206 assesses the aggregate impacts of selected data files on individual data centers and/or data nodes, evaluating how data files affect resource performance, resource allocation, and operational efficiency, and generating reports. In some embodiments, recommendation module 208 provides strategic insights and recommendations based on the analysis performed by the other modules, helping decision-makers understand the implications of different data pathways and make informed choices. These modules work together within the transformation engine 200 to process data, perform analyses, and deliver insights that enhance the data integration process and decision-making for data networks.

It should be understood that the engine(s) and modules discussed herein are non-exhaustive, as additional, or fewer engines and/or modules (or sub-modules) may be applicable to the embodiments of the systems and methods discussed. More details of the operations, configurations, and functionalities of transformation engine 200 and each of its modules, and their role within embodiments of the present disclosure will be discussed below.

Turning to FIG. 3, process 300 provides non-limiting example embodiments for the disclosed contract injection feature. According to some embodiments, process 300 provides non-limiting embodiments for integrating existing data files into the system for which the disclosed framework (e.g., via transformation engine 200) is configured to control, manage, and manipulate the data files, data sources, and/or data inputs on UE 102. steps described in the figures represent both an execution of a computer algorithm and a method of implementing the system.

According to some embodiments, steps 302-304 of process 300 can be performed by the data normalization module 202 of transformation engine 200; step 306 can be performed by the data analysis module 204; steps 308-310 can be performed by the data assessment module 206; and steps 312-314 can be performed by the data recommendation module 208. It should be understood that while the discussion herein will be with reference to data file management, it should not be construed as limiting, as any type of program, website, network resource, platform, or device (e.g., any of the UEs discussed above) can form the basis of data file analysis without departing from the scope of the instant disclosure. While specific non-limiting examples are presented below in relation to transformation engine 200, all functionalities can generally be described as executed by the system in some embodiments.

In some embodiments, process 300 begins with step 302 where the transformation engine 200 is configured to retrieve existing electronic data files from a centralized or other desired repository. Some embodiments utilize advanced AI capabilities to execute data retrieval methods through API calls, database queries, and the like, to ensure a comprehensive acquisition of relevant data. In some embodiments, transformation engine 200 employs machine learning algorithms, such as clustering and classification models, to efficiently filter data files based on participation status and commitment type, categorizing them according to their attributes and determining their relevance to specific data integration needs. In some embodiments, natural language processing (NLP) techniques are utilized to parse and analyze the contents of data files, extracting key terms and conditions for further analysis. In some embodiments, predictive analytics enhance transformation engine 200's capability to forecast the performance and compliance risks of data files by analyzing historical patterns, thereby improving or optimizing the retrieval and filtering processes to align with the system's data integration objectives.

In some embodiments, step 302 involves categorizing data files into direct, national, and/or local data types, as a non-limiting example. This categorization may leverage AI techniques to streamline the organization and analysis of data files. For instance, in some embodiments, direct data files represent those that are integrated directly between individual data networks and data sources by transformation engine 200. The system enables direct data integration, granting data networks (which may include data centers and data nodes) enhanced control over data terms and metrics by enabling one-on-one negotiation with data sources. This approach allows for customized agreements tailored to the specific needs of the data network, including considerations for volume, metrics, and service specifications. In some embodiments, the system optimizes this categorization process, by incorporating machine learning and NLP, ensuring that the management of data files is aligned with system objectives and data integration best practices.

In some embodiments, national data files include data files from different data networks that are aggregated and/or grouped such that they are available and/or viewable to a majority (or all) system users. In some embodiments, national data files are negotiated using a majority of system user profiles and/or the entire member network to leverage collective data processing power and obtain competitive metrics and favorable terms from data sources. Because they serve a large member base, national data files often offer standardized metrics and terms that cater to a broad audience. National data files are beneficial for data networks looking for stable, standardized metrics across a wide range of data inputs.

In some embodiments, local data files refer to agreements that are negotiated for a regional group of data networks and/or a single data network and/or the data centers associated therewith. In some embodiments, local data files are tailored to meet the unique needs of specific data centers or regions, and they allow data networks to negotiate terms that may better reflect their local conditions, processing needs, or budgetary constraints. In some embodiments, the transformation engine 200 is configured to manage local data files to allow data networks to benefit from the system's functionality even when not using the national data file options.

In some embodiments, custom data files refer to agreements that are specifically tailored to the unique requirements of individual data networks. These custom data files are designed to address specific needs, metrics, and service specifications that are not covered by standard national or local data files. By allowing for custom configurations, custom data files enable data networks to negotiate terms that align closely with their operational goals, data integration strategies, and resource constraints. Transformation engine 200 facilitates the creation and management of these custom data files, ensuring that data networks can leverage the system's capabilities to achieve optimal data integration outcomes.

In some embodiments, aggregation data files refer to agreements that consolidate data processing needs across multiple data networks to leverage collective resources and efficiencies. These aggregation data files are configured to unify the data integration efforts of various data centers and data nodes, enabling them to achieve economies of scale and enhanced data processing capabilities. By pooling resources and aligning data strategies, aggregation data files allow data networks to obtain more favorable terms with data sources, optimizing metrics and service specifications. The system supports the management of these aggregation data files, ensuring that participating data networks can benefit from shared insights and collaborative data management practices. This approach enhances the overall data integration process by fostering cooperation among data networks, leading to improved resource utilization and strategic data outcomes.

In some embodiments, the categorization executed in step 302 provides a comprehensive view of available electronic data file options, in accordance with some embodiments. Indeed, in some embodiments, the data file information can be determined and/or provided and can correspond to the data integration needs. For example, data files can be marked as existing, active or eligible; however, if a data file is inactive, for example, then it may or may not be included in the analysis. In some embodiments, transformation engine 200 leverages machine learning algorithms to automatically classify data files based on their status and relevance to current data integration objectives.

In step 304, the transformation engine 200 is configured to incorporate one or more of these electronic data files into the data integration planning process. In some embodiments, transformation engine 200 analyzes the data files alongside current data input options. AI-driven techniques, such as machine learning, are used in some embodiments to evaluate the relevance and compatibility of each data file with current data integration needs. This incorporation extends the functionality of the data source selection feature to distinguish between current data input options and existing data files.

In step 306, the system is configured to analyze the collected data files. This analysis can involve any type of known or to be known computational methods that enable the system to derive, determine, extract, retrieve, or otherwise compare data file terms and metrics. In some embodiments, AI-driven techniques, such as natural language processing (NLP), are employed to parse the data files, extracting information indicating metric tiers, compliance performance, and potential efficiencies.

In step 308, transformation engine 200 is configured to generate a comprehensive comparison report. In some embodiments, this report quantifies data input and/or data source alternatives in terms of resource utilization, efficiencies, conversion rates, data quality, and standardization. AI-driven analytics, utilizing machine learning algorithms and predictive modeling, can provide strategic insights into the most beneficial data integration pathways. In some embodiments, these analytics assess historical data patterns and forecast potential outcomes, highlighting options that optimize resource allocation and align with data network objectives.

In step 310, transformation engine 200 is configured to display strategic recommendations on the data management GUI. These recommendations are based on the comprehensive comparison report and include optimal data integration pathways and actionable insights for resource efficiencies in accordance with some embodiments.

In step 312, transformation engine 200 is configured to execute a series of algorithmic steps to carry out the enrollment process for eligible data files in accordance with some embodiments. Transformation engine 200 accesses data file eligibility information from the database 108 to identify data files available for enrollment. In some embodiments, transformation engine 200 then automatically generates and submits enrollment requests for selected data files. For aggregation data files, the system manages collective acceptance requirements and ensures compliance with group terms. In some embodiments, transformation engine 200 continuously or periodically monitors the status of enrollment requests, automatically recording successful enrollments. Upon successful enrollment, in some embodiments, automated notifications are sent to data networks, confirming their participation with the newly integrated data files. In some embodiments, the data network platforms are updated with the new enrollment details, ensuring that all relevant data is current and accessible for future reference.

In step 314, transformation engine 200 is configured to execute one or more steps to implement the selected data files. In some embodiments, transformation engine 200 verifies that all data file obligations are met by executing compliance checks against predefined criteria stored within the system. In some embodiments, transformation engine 200 initiates the implementation of data file terms, coordinating with relevant data centers and/or data nodes to align processes and resources within a data management platform according to the data file specifications. The system standardizes data processes across the data network by updating internal platform databases with the standardized terms and conditions outlined in the data files. Throughout the execution process, the system continuously or periodically monitors compliance and performance metrics, providing real-time updates and alerts to ensure adherence to data file obligations, ensuring that the execution of data files is efficient, compliant, and aligned with data network standards in accordance with some embodiments.

Referring to FIG. 4, process 400 provides non-limiting algorithmic steps for independent data file analysis, which includes evaluating existing data files independently of active data integration events for which the disclosed system (e.g., via transformation engine 200) is configured to control, manage, and/or manipulate the data file analysis via UE 102. Steps described in the figures represent both an execution of a computer algorithm and a method of implementing the system.

According to some embodiments, steps 402-404 of process 400 can be performed by normalization module 402; step 406 can be performed by analysis module 404; steps 408-410 can be performed by assessment module 406; and steps 412-414 can be performed by recommendation module 408.

According to some embodiments, process 400 begins with step 402 where transformation engine 200 is configured to retrieve and/or review existing data files independently. As mentioned previously, any program can be executed by UE 102 (e.g., using the data file evaluation software), which may include execution of one or more program steps on cloud platform 106. By way of non-limiting examples, this can include any type of known or to be known data retrieval method such as, but not limited to, API calls, database queries, and the like, or some combination thereof. In some embodiments, transformation engine 200 is configured to assess data file terms, metrics, and/or performance. Step 402 includes the system evaluating whether terms are still favorable and if metrics are competitive.

In step 404, transformation engine 200 is configured to identify and/or display strategic insights from the data files. These strategic insights include opportunities for improvement, such as renegotiating terms or consolidating data files, enabling data networks to proactively manage their resources in accordance with some embodiments. In some embodiments, AI-driven analytics may be employed to uncover patterns and trends within the data files and/or data inputs, providing actionable recommendations for optimizing data integration strategies and enhancing overall data management platform efficiency.

In step 406, transformation engine 200 is configured to assess the resource optimization potential of existing data files. In some embodiments, this assessment involves determining and/or displaying the (full) scope and impact of data files on resource allocation and efficiency gains, which supports efforts to standardize data processes across the data network. AI-driven analytics, such as predictive modeling and clustering algorithms, may be utilized to evaluate the data files'influence on resource distribution. In some embodiments, predictive modeling forecasts potential outcomes based on historical data patterns, while clustering algorithms group similar data attributes to identify optimization opportunities and align them with strategic data integration goals.

In step 408, transformation engine 200 is configured to generate and/or display compliance improvement recommendations, in accordance with some embodiments. In some embodiments, these recommendations include analyzing compliance trends over time and providing actionable insights to enhance adherence to data file terms, supporting efforts to ensure compliance with data file obligations. In some embodiments, AI-driven analytics, such as time-series analysis and anomaly detection, are employed to monitor compliance patterns. In some embodiments, time-series analysis identifies trends and deviations over time, while in some embodiments, anomaly detection highlights irregularities that may indicate compliance risks, enabling data networks to proactively address potential issues and maintain alignment with data management standards.

In step 410, transformation engine 200 is configured to display a strategic recommendation report, in accordance with some embodiments. In some embodiments, this report includes insights into optimal data integration pathways and actionable strategies for data integration planning. In some embodiments, AI-driven analytics, such as decision tree analysis and optimization algorithms, are utilized to evaluate potential pathways and strategies. In some embodiments, decision tree analysis helps in visualizing decision-making processes by mapping out possible outcomes, and/or optimization algorithms identifying the most efficient routes for data integration, providing data networks with informed strategies to enhance their data integration efforts.

In step 412, transformation engine 200 is configured to execute the acceptance process for eligible data files in accordance with some embodiments. In some embodiments, the system accesses data file eligibility information from the database 108 to identify files available for enrollment. In some embodiments, transformation engine 200 then automatically generates and submits acceptance requests for selected data files. For aggregation data files, the system manages collective acceptance requirements and ensures compliance with group terms in accordance with some embodiments. In some embodiments, transformation engine 200 continuously monitors the status of enrollment requests, automatically recording successful enrollments. Upon successful enrollment, in some embodiments, automated notifications are sent to data networks, confirming their participation in the newly integrated data files. In some embodiments, the database 108 is updated with the new enrollment details, ensuring that all relevant data is current and accessible for future reference.

In step 414, transformation engine 200 is configured to execute data file compliance checks. In some embodiments, transformation engine 200 verifies that all data file obligations are met by executing compliance checks against predefined criteria stored within the database 108. In some embodiments, transformation engine 200 initiates the implementation of data file terms, which may include notifying and/or supporting coordination with relevant data networks, data centers, and/or data nodes to align processes and resources according to the data file specifications. In some embodiments, transformation engine 200 standardizes processes across the data network by updating internal databases (such as database 108) and related platforms with the standardized terms and conditions outlined in the data files. Throughout the compliance check process, the system continuously or periodically monitors compliance and performance metrics, providing real-time updates and alerts to ensure adherence to data file obligations, ensuring that the execution of data files is efficient, compliant, and aligned with data network standards, in accordance with some embodiments.

In some embodiments, such computational analysis described in process 300 and/or process 400 can involve transformation engine 200 executing any type of known or to be known computational analysis technique, algorithm, mechanism, or technology. In some embodiments, engine 200 may include a specific trained artificial intelligence (AI) model, which may include one or more of a particular machine learning model architecture, a particular machine learning model type (e.g., convolutional neural network (CNN), recurrent neural network (RNN), autoencoder, support vector machine (SVM), and the like), or any other suitable definition of an AI model or any suitable combination thereof.

In some embodiments, transformation engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, XGBoost algorithms, and the like. In some embodiments, by leveraging machine learning algorithms, natural language processing (NLP), and/or predictive analytics, the system is configured to optimize data file lifecycle management, from data file retrieval to execution.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model for the control framework,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained AI model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained AI model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

FIG. 7 is a schematic diagram illustrating a client device showing an example embodiment of a client device that may be used within the present disclosure and/or the framework illustrated in FIG. 1. Client device 700 may include many more or fewer components than those shown in FIG. 7, such as a plurality of computers. However, the components shown are sufficient to disclose an illustrative embodiment for implementing the present disclosure. Client device 700 may represent, for example, UE 102 discussed above at least in relation to FIG. 1.

As shown in the figure, in some embodiments, client device 700, which may include UE 102, includes one or more processors (CPU) 722 in communication with one or more non-transitory computer readable media 730 via a bus 724. In some embodiments, client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal, or electromagnetic sensors 766. In some embodiments, device 700 can include one camera/sensor 766, or a plurality of cameras/sensors 766, as understood by those of skill in the art. Power supply 726 provides power to client device 700.

Client device 700 may optionally communicate with a base station (not shown), or directly with another computing device. In some embodiments, network interface 750 is sometimes known as a transceiver, transceiving device, or network interface card (NIC).

In some embodiments, audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. In some embodiments, illuminator 758 may provide a status indication and/or provide light.

In some embodiments, client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In some embodiments, however, the client device 700 may, through other components, provide other information that may be employed to determine a physical location of the device, including for example, a MAC address, Internet Protocol (IP) address, or the like.

In some embodiments, mass memory 730 includes a RAM 732, a ROM 734, and/or other non-transitory storage means. Mass memory 730 illustrates another example of computer storage media for storage of information such as computer readable instructions, data structures, program modules, usage data, or other data. In some embodiments, mass memory 730 stores a basic input/output system (“BIOS”) 740 for controlling low-level operation of client device 700. In some embodiments, the mass memory also stores an operating system 741 for controlling the operation of client device 700.

In some embodiments, memory 730 further includes one or more data stores, which can be utilized by client device 700 to store, among other things, applications 742 for executing transformation engine 200, and/or other information or data. For example, data stores may be employed to store information that describes various capabilities of client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within client device 700.

In some embodiments, applications 742 may include computer executable instructions which, when executed by client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with transformation engine 200 and its affiliates.

In some embodiments, the system includes one or more (e.g., 5) archetypes within various models of data integration across a network of data centers and nodes, in accordance with some embodiments. In some embodiments, these archetypes encompass a spectrum from fully integrated systems, where data centers and data nodes operate in a closely linked manner, to separate systems, where data centers and nodes function independently. The system framework supports a plurality of archetypes, in accordance with some embodiments, implemented through various GUIs, facilitating data integration that adapts to different levels. This flexibility enables the data network to optimize data inputs and outputs based on the specific needs and structure of each archetype, ensuring efficient resource allocation and alignment with organizational goals.

In some embodiments, an archetype includes a fully integrated model where data centers and data nodes are seamlessly integrated, functioning as a single cohesive unit. In some embodiments, the system enables the sharing and utilization of data inputs across the network without barriers, enabling real-time data exchange and collaboration, maximizing resource efficiency and data quality by leveraging the strengths of both data centers and nodes. A non-limiting example may include a fully integrated academic and clinical practice framework.

In some embodiments, an archetype includes a collaborative partnership model where data centers and data nodes maintain distinct identities but collaborate closely on specific projects or data integration initiatives. In some embodiments, the system enables this collaboration by enabling users to execute system tools for joint data management and analysis. In some embodiments, the system is configured to allow data inputs to be selectively shared based on mutual goals. A non-limiting example includes a partnership between universities and clinical practices on research projects.

In some embodiments, an archetype includes a centralized control model, which includes a configuration where the data center acts as the central hub, controlling and distributing data inputs to various data nodes. In some embodiments, the system is configured to enable, for example through the GUIs described below, a data center to set the standards and protocols for data integration, ensuring consistency and compliance across the network. A non-limiting example may include a university setting guidelines for affiliated clinical practices.

In some embodiments, an archetype includes a decentralized model that features a network where data nodes operate independently, with minimal oversight from the data center. The system allows each node to manage its own data inputs and integration processes, providing flexibility and customization based on local needs. A non-limiting example may include a scenario where clinical practices operate autonomously, with a university providing occasional support or resources.

In some embodiments, an archetype includes a hybrid model that combines elements of both centralized and decentralized models. In some embodiments, data centers provide overarching guidelines and support, while data nodes have the autonomy to manage their data inputs and integration processes. This model, in accordance with some embodiments, allows for a balance between standardization and flexibility. A non-limiting example may include a university providing a framework for clinical practices while allowing them to tailor their operations to specific patient populations or specialties.

In some embodiments, the system is configured to compare data network performance against peers for strategic decision-making. By leveraging data metrics and analytics generated by the system, in some embodiments, the system can evaluate the performance of data centers and nodes relative to similar entities. In some embodiments, this comparison allows the network to identify areas for improvement and adjust commitments or strategies to enhance performance. The system's comprehensive comparison reports, in accordance with some embodiments, provide insights into data utilization, resource efficiency, and data quality, enabling data networks to benchmark their operations against peers and implement best practices to achieve competitive advantage.

In some embodiments, the system enhances the value of integration between data centers and data nodes by optimizing data inputs and outputs. By facilitating seamless data integration, in some embodiments, the system ensures that both sides benefit from improved data quality and resource efficiency. In some embodiments, the recommendation module 208 is configured to provide insights into optimal data pathways, helping decision-makers understand the implications of different data integration strategies. The alignment of data resources with operational goals enhances the overall value proposition for both data centers and nodes, fostering collaboration and innovation.

In some embodiments, the system includes support for community centers by academic practitioners (e.g., data nodes receiving inputs from data centers). In some embodiments, the system is configured to manage data files that outline the terms and conditions of such collaborations. In some embodiments, the system is configured to execute management of data inputs and/or the optimization of data processes, thereby enhancing their operational effectiveness.

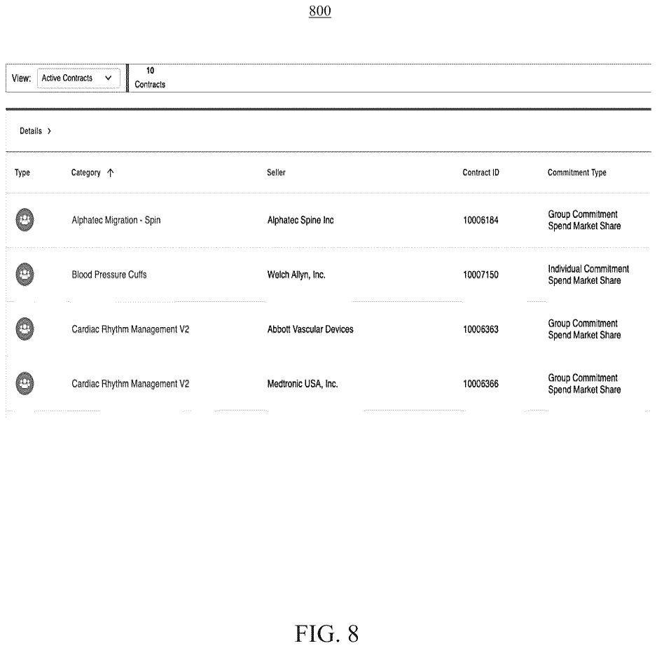

FIG. 8 illustrates a data management GUI 800 configured to enhance the data integration process by providing a comprehensive view of relevant data files, data sources, and/or data inputs according to some embodiments of the present disclosure. In some embodiments, the GUI 800 includes a page that lists data files pertinent to the defined scope, where the page is equipped with one or more filters to refine the display. In some embodiments, data files are marked to indicate whether they are direct, national, custom, or local, as non-limiting examples, allowing users to easily identify the type of data file.

In some embodiments, the GUI 800 is configured to display a difference between data files the user is currently utilizing and those for which they are eligible, providing clarity on available options. Additionally, in some embodiments, the GUI 800 indicates whether data files are solo or group, as well as whether they involve collective or individual commitments. In some embodiments, the GUI 800 is configured to display the data file's coverage within the currently defined scope and may include aspects such as categories, subcategories, or incumbent data usage, with options to display further details. For specific data files in which users are participating, in some embodiments, the GUI 800 includes information on current tier metrics and compliance performance. In some embodiments, the GUI 800 displays an option to add a data file to the analytics of the integration process, allowing one or more data files to be considered during the data integration planning process.

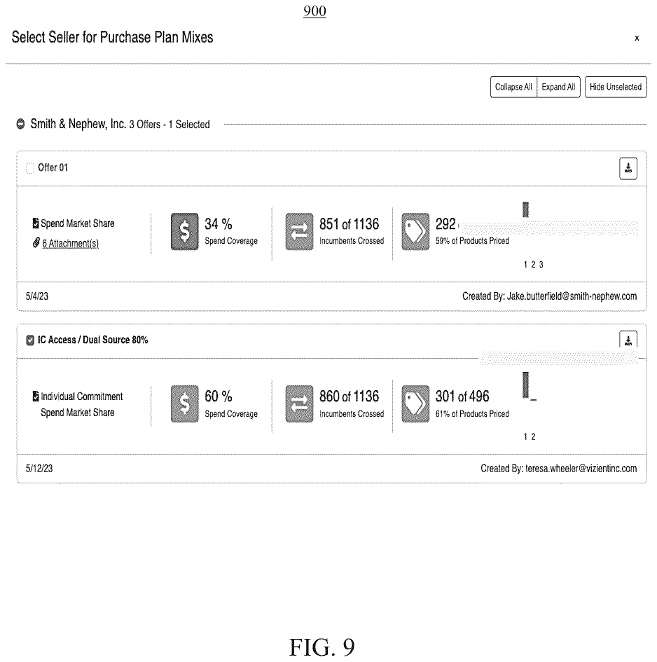

FIG. 9 depicts a GUI 900 configured to optimize the data integration planning process by incorporating added data files into the decision-making framework in accordance with some embodiments. In some embodiments, the GUI 900 is configured to display integrated data files and/or display data integration pathways and/or combinations. In some embodiments, the GUI 900 is configured to clearly differentiate between “current data source options” (current inputs from data sources) and “existing data files” (data file agreements already in place). This distinction helps users understand which options are newly proposed and which are already established. In some embodiments, the GUI 900 provides users with the ability to incorporate both current data source options and existing data files into their data integration plans. When planning data integration or strategizing data pathways, this allows users to consider both new data inputs and existing data files as part of their decision-making process. The process for adding existing data files to a plan is as straightforward as adding current data source options, ensuring that users can seamlessly integrate different types of data files into their data integration strategies without having to navigate different procedures for each in accordance with some embodiments.

In some embodiments, the GUI 900 allows users to view and select from a list of current data source options and existing data files. In some embodiments, users can explore details about each option, such as metrics, terms, and compliance metrics, to make informed decisions. In some embodiments, the system may enforce a rule that limits a data integration plan to include only one data source option at a time, which prevents conflicts or complications that could arise from trying to execute multiple data source options simultaneously. For example, different data source options might have conflicting terms, delivery schedules, or metric structures that could complicate data integration execution. While the rule limits the plan to one data source option at a time, in some embodiments, the GUI 900 is configured to allow users to easily switch between different data source options and/or data files. In some embodiments, the GUI 900 allows for re-evaluation and modification of the plan as new information or data source options become available, providing flexibility in decision-making.

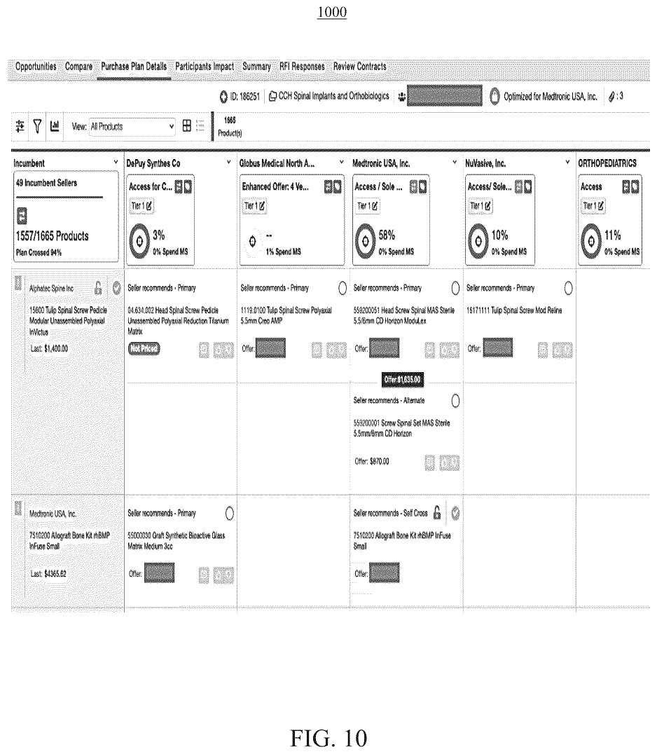

FIG. 10 illustrates a GUI 1000 configured to enhance the data integration planning process by displaying a detailed view of included data files on a data integration plan details page according to some embodiments. In some embodiments, the data integration plan details page is configured to identify any included data files and/or distinguish them from current data source options. This distinction ensures that users can easily identify which data files are pre-existing and which data files are proposed. In some embodiments, the GUI 1000 is configured to display tiers, categories, and metrics for included data files in the same fashion as current data source options, maintaining consistency in presentation.

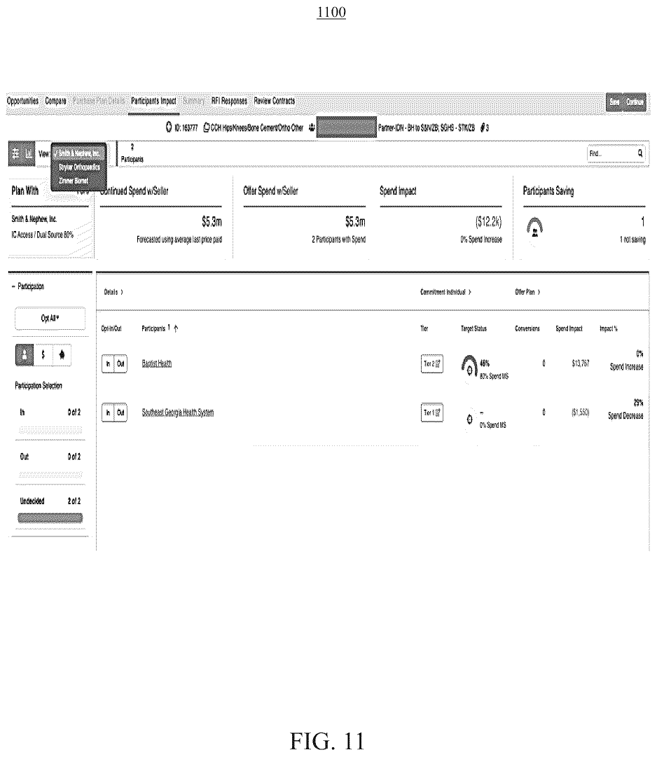

FIG. 11 shows a GUI 1100 configured to provide a comprehensive analysis of the impact of selected data files on individual data centers or data nodes on a participants impact page in accordance with some embodiments. In some embodiments, the participants impact page enables users to choose any selected data files and assess their aggregate impacts on each data network, data center, and/or data node, allowing users to evaluate how specific data files influence operational and resource metrics across different locations. In some embodiments, the GUI 1100 is accessible both pre-submit, e.g., during the creation of a data integration proposal, and during the data integration planning for a process containing open (not yet finalized) data source options. This dual accessibility ensures that users have direct and immediate access to the data integration planning, facilitating informed decision-making at every stage of the data integration process.

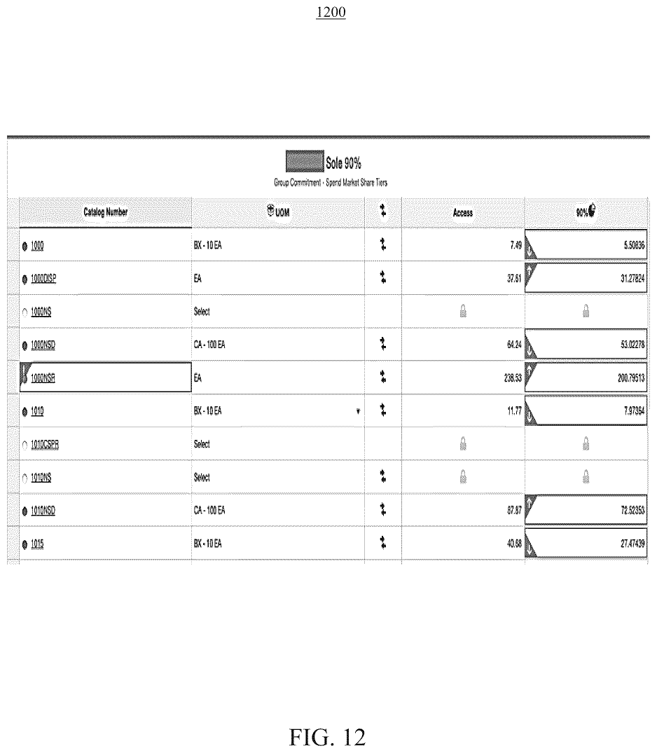

FIG. 12 illustrates a GUI 1200 providing additional insights and communication capabilities according to some embodiments. In some embodiments, if data file details are added pre-submit, the GUI 1200 is configured to supply data sources with relevant insights and details about the data integration environment or requirements, further enhancing the data source's input experience. “Pre-submit” refers to the stage before a data source submits their data input or option in response to a data integration proposal. At this stage, in some embodiments, data file details are added to the system, which can include information about existing agreements, terms, conditions, and any relevant data that might impact the data source's input. In some embodiments, the system uses the added data file details to enhance the data source's understanding of the current data landscape, helping data sources tailor their inputs to better align with the data network's needs and existing data files. By having access to detailed data file information, data sources can make more informed decisions about metrics, terms, and conditions for their data inputs. This can lead to more competitive and relevant data options that are better suited to the data network's requirements. In some embodiments, this feature ensures that data sources are aware of the context in which they are submitting their data inputs, allowing them to strategically position their integration options, leading to improved alignment between data source options and the data network's integration goals.

Additionally, in some embodiments, the GUI 1200 shown in FIG. 12 is configured to inform other data sources of the presence of national data files, providing limited or aggregated details. This feature promotes transparency and encourages competitive data contributions by ensuring that all data sources are aware of existing data files, enabling a more informed and competitive data integration environment, supporting strategic decision-making and optimizing interactions with data sources.

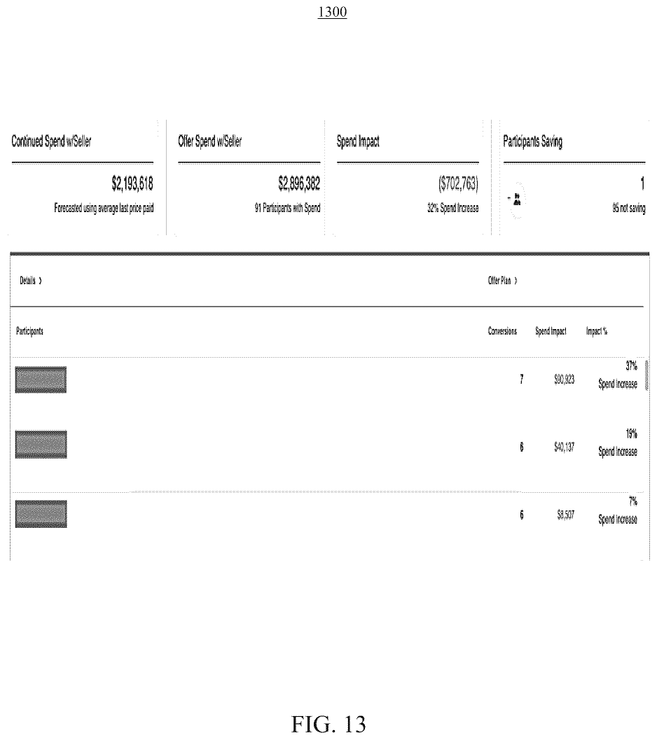

FIG. 13 illustrates a GUI 1300 configured to provide enhanced analytical capabilities for evaluating data source options in accordance with some embodiments. In some embodiments, the system is configured to analyze whether a data source option at a given tier is competitive by comparing the option to a data center's current metrics and the associated data files, displaying the results on an option impacts page. This allows users to assess the competitiveness of data source inputs in the context of existing data files and data market conditions. The option impacts page enables users to identify opportunities for resource efficiencies and optimize interactions with data sources, ensuring that data integration decisions align with data network goals and resource objectives.

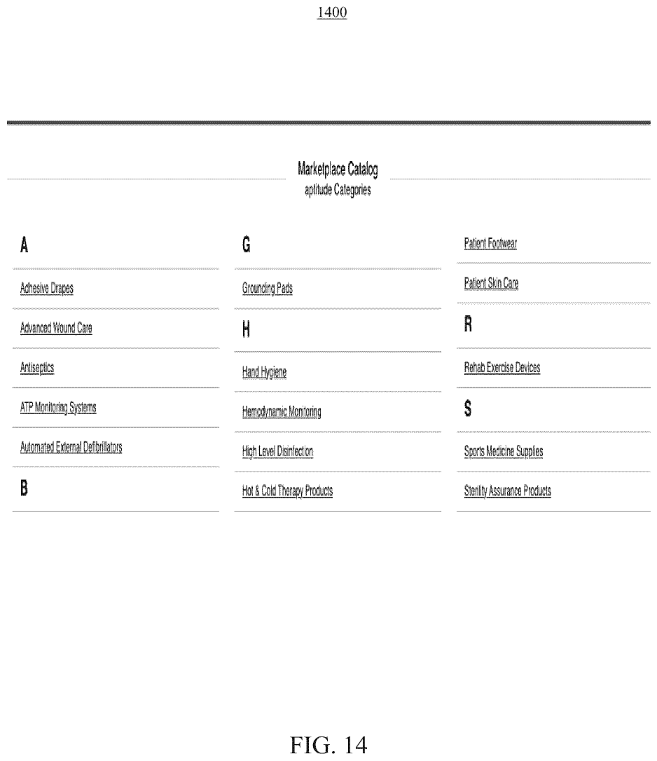

FIG. 14 shows a data management GUI 1400 that integrates existing data files into a catalog and categories page in accordance with some embodiments. In some embodiments, the system is configured to enable existing data files to augment the catalog, where the GUI 1400 displays relevant data file information in the categories page. In some embodiments, the GUI 1400 is configured to display a comprehensive view of available data files within each category for easier navigation and selection. Additionally, in some embodiments, the GUI 1400 includes a direct link feature that enables users to analyze a given data file by seamlessly transitioning the GUI 1400 from the initial data file selection to a more interactive and detailed data integration planning environment. This feature streamlines the workflow by eliminating the need for users to navigate through multiple pages or interfaces to conduct an analysis. In some embodiments, when users select a data file from the catalog or categories page, the direct link feature enables them to immediately access tools and data necessary for a comprehensive analysis of that data file. This might include examining terms, metrics, compliance metrics, and other relevant details. This functionality ensures that users can seamlessly transition from browsing data file categories to conducting in-depth analyses, supporting efficient and informed data integration planning.

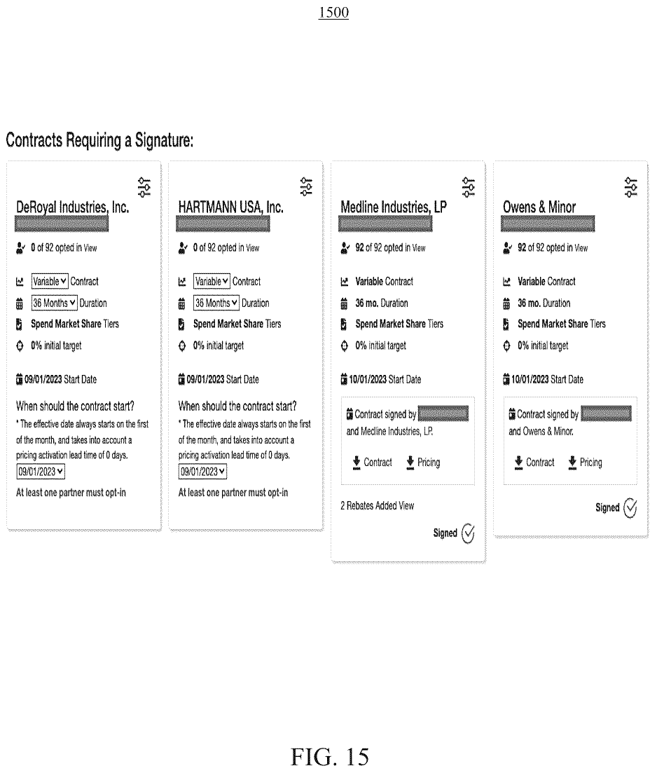

FIG. 15 illustrates a GUI 1500 feature that improves the acceptance process for data networks by offering a direct pathway to engage with eligible data files. While analyzing an existing data file, the GUI 1500 is configured to provide users with a direct link that enables them to accept in any eligible data file they do not currently utilize. In this non-limiting example, the GUI 1500 includes a link to national data files, allowing data networks to access and enroll in these data files to facilitate enrollment in aggregation data files, ensuring that all necessary steps are taken to join collective data file agreements.

As used in this disclosure, in some embodiments, a data network is a term used to describe an organization, which may include a network of data centers and data nodes. In some embodiments, a data center refers to a hospital or facility, for example, representing individual units within the data network where data inputs are consumed and/or utilized. A data node, in some embodiments, is used to describe people such as employees or faculty, which make up entities within a data center.

A data source is a term that can mean a supplier, such as a merchant supplier providing data inputs to the network, where the data inputs are selected during data integration in accordance with some embodiments. In some embodiments, data source options refer to data files offered by data sources, which may include a bid. In some embodiments, data integration is a term that can refer to a procurement process for data inputs. Data inputs can refer to services and/or products offered by the data source to the data network as outlined in a data file according to some embodiments. A data file, in some embodiments, is a term used to describe a contract, which included structured agreements within the network. Existing data files refer to contracts already held by the data network, where available data files refer to contracts offered by a data source for consideration.

Data utilization, resource efficiency, conversion, and data quality, can mean spending, cost, supplier switching, and service/product quality, respectively, in accordance with some embodiments. In some embodiments, the term current data input refers to a current and/or active proposal or bid from a supplier that is available for consideration by a data network. In some embodiments, data metrics refer quantitative measures used to assess various aspects of the product/service, such as quality, volume, or efficiency. Data network platforms, in some embodiments, refer to data input management software for a particular data network.

As used herein, the term “engine” identifies at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether some embodiments are implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

One or more aspects of some embodiments may be implemented by representative instructions stored on a machine-readable medium which represents various logic within the processor, which when read by a machine causes the machine to execute logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional program and/or method steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example. “Substantially” and “approximately” when used in conjunction with a value encompass a difference of 5% or less of the same unit and/or scale of that being measured. “Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations thereof (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function according to some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

For the purposes of this disclosure the term “user,” “subscriber” “provider,” “supplier,” or “customer” should be understood to refer to a user of an application or applications as described herein and/or a consumer of data. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by some embodiments and examples. In other words, functional elements being performed by single or multiple components, in various combinations of hardware and software or firmware, and individual functions, may be distributed among software applications at either the client level or server level or both. In this regard, any number of the features of some embodiments described herein may be combined into single or multiple configurations, and some embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, some embodiments of computer implemented methods presented and described as flowcharts in this disclosure are provided by way of non-limiting example in order to provide a more complete understanding of the technology. The disclosed methods are not limited to the operations and logical flow presented herein. Some embodiments are contemplated in which the order of the various operations is altered and in which sub-operations described as being part of a larger operation are performed independently.

While some embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
receiving existing electronic data files from a centralized repository;
analyzing a scope of each data file in relation to current data network integration needs;
transforming data from these files into a comparative format against data inputs from data sources through a data transformation engine;
generating a comparison report that quantifies alternatives in terms of data utilization, resource efficiency, conversion rates, data quality, and/or standardization; and
displaying the comparison report on a graphical user interface (GUI).

2. The method of claim 1, further comprising:
filtering data files based on file type.

3. The method of claim 1, further comprising:
retrieving and analyzing data metrics and compliance performance data for data files.

4. The method of claim 1, further comprising:
incorporating selected data files into a data integration planning process.

5. The method of claim 1, further comprising:
assessing an aggregate impact of selected data files on components of a data network.

6. The method of claim 1, further comprising:
enabling pre-submit access to data file details during a creation of a data integration proposal.

7. The method of claim 1, further comprising:
executing an independent analysis of existing data files outside of a data integration event.

8. The method of claim 7, further comprising:
transforming data file information into data integration analytics.

9. The method of claim 7, further comprising:
identifying opportunities to optimize resources, reduce variation, and improve compliance.

10. The method of claim 7, further comprising:
displaying the existing data files on the GUI.

11. A device comprising:
a computer configured to:
receive existing electronic data files from a centralized repository;
analyze a scope of each data file in relation to current data network integration needs;
transform data from these files into a comparative format against data inputs from data sources through a data transformation engine;
generate a comparison report; and
display the comparison report on a graphical user interface (GUI).

12. The device of claim 11,
wherein the computer is configured to filter data files based on attributes such as file type, participation status, and commitment type.

13. The device of claim 11,
wherein the computer is configured to retrieve and analyzes current tier data metrics and compliance performance data for data files.

14. The device of claim 11,
wherein the computer is configured to incorporate selected data files into a data integration planning process.

15. The device of claim 11,
wherein the computer is configured to assess an aggregate impact of selected data files on components of a data network.

16. A non-transitory computer-readable storage medium tangibly encoded with computer-executable instructions that when executed by a computer, perform a method comprising:
receiving existing electronic data files from a centralized repository;
analyzing a scope of each data file in relation to current data network integration needs;
transforming data from these files into a comparative format against data inputs from data sources through a data transformation engine;
generating a comparison report; and
displaying the comparison report on a graphical user interface (GUI).

17. The non-transitory computer-readable storage medium of claim 16,
wherein the instructions include filtering data files based on attributes such as file type, participation status, and commitment type.

18. The non-transitory computer-readable storage medium of claim 16,
wherein the instructions include retrieving and analyzing current tier data metrics and compliance performance data for data files.

19. The non-transitory computer-readable storage medium of claim 16,
wherein the instructions include incorporating selected data files into a data integration planning process.

20. The non-transitory computer-readable storage medium of claim 16,
wherein the instructions include assessing an aggregate impact of selected data files on components of a data network.
